(19) United States
(12) Patent Application Publication
(10) Pub. No.: US 2025/0358151 A1
(43) Pub. Date: Nov. 20, 2025

(54) CHANNEL VARIATION REPORTING IN COMMUNICATION SYSTEM

(71) Applicant: HUAWEI TECHNOLOGIES CO., LTD., Shenzhen (CN)

(72) Inventors: Salah Eddine Hajri, Kista (SE); Xinze Li, Aalto (FI); Olav Tirkkonen, Aalto (FI); Hanan Hassan Al-Tous, Aalto (FI)

(73) Assignee: HUAWEI TECHNOLOGIES CO., LTD., Shenzhen (CN)

(21) Appl. No.: 19/288,705

(22) Filed: Aug. 1, 2025

Related U.S. Application Data
(63) Continuation of application No. PCT/EP2023/052692, filed on Feb. 3, 2023.

(51) Int. Cl. H04L 25/02

(52) U.S. Cl. CPC H04L 25/0222; H04L 25/0224

(57) ABSTRACT

A client device for a communication system is configured to determine a channel variation metric between a first channel estimate and a second channel estimate for the client device. The client device is also configured to transmit a first control signal to a network node. The first control signal indicating the channel variation metric.

### CROSS-REFERENCE TO RELATED APPLICATIONS

This application is a continuation of International Application No. PCT/EP2023/052692, filed on Feb. 3, 2023, the disclosure of which is hereby incorporated by reference in its entirety.

### TECHNICAL FIELD

Embodiments of the present disclosure relate to channel variation reporting for a client device in a communication system. Furthermore, embodiments of the present disclosure also relate to a network node, corresponding methods and a computer program.

### BACKGROUND

In 3GPP release 16, new radio positioning protocol (NRPPa) was first specified to support several location technologies, targeting both commercial and regulatory use cases. NRPPa introduced several enhancements compared to LTE positioning protocol (LPP), leveraging the high spatial resolution expected from 5G equipment beamforming capabilities. The performance of NRPPa was further improved in 3GPP release 17, in terms of latency, power consumption and accuracy. 3GPP release 18 continues the work on augmenting new radio (NR) positioning capabilities. Therein a study item for expanded and improved positioning was agreed, targeting sidelink positioning, improved accuracy, integrity and power efficiency, and positioning support for reduced capability user equipment (UE).

Additionally, 3GPP release 18 includes a study item on artificial intelligence (AI)/machine learning (ML) for NR. The study item will explore different aspects of a potential 3GPP framework for ML operation in the air interface and three main use cases were considered, namely, positioning accuracy, beam management and channel state information (CSI) reporting enhancements based on ML methods.

For ML-based positioning accuracy enhancements, two approaches are considered, direct AI/ML and AI/ML assisted positioning, respectively, with possible implementations include one sided and two-sided models. Additionally, different other relevant aspects are considered, most importantly relevant to model life cycle management. This includes model training, inference/configuration, performance monitoring and update, inference input collection, inference output reporting/indication, among others.

### SUMMARY

An objective of embodiments of the present disclosure is to provide a solution which mitigates or solves the drawbacks and problems of conventional solutions.

Another objective of embodiments of the present disclosure is to provide a solution which reduces power consumption at the client device for positioning without degrading positioning accuracy.

The above and further objectives are solved by the subject matter of the independent claims. Further embodiments of the present disclosure can be found in the dependent claims.

According to a first aspect, the above mentioned and other objectives are achieved with a client device for a communication system, the client device being configured to:
determine a channel variation metric between a first channel estimate and a second channel estimate for the client device; and
transmit a first control signal to a network node, the first control signal indicating the channel variation metric.

An advantage of the client device according to the first aspect is that the client device can provide the network node with insightful information on the variation of the channel characteristics, especially the spatial and delay supports, using a reduced overhead. A substantial variation of the channel characteristics indicates a change in large scale parameters of the channel and hence a movement by the client device. The reported channel variation metric hence allows the client device to indicate its movements to the network node in an efficient way.

In an implementation form of a client device according to the first aspect, the channel variation metric is a distance metric indicating a distance between the first channel estimate and the second channel estimate.

An advantage with this implementation form is that the channel variation metric captures the distance, especially in terms of spatial and delay supports, between two different channel estimates, which may be performed on downlink reference signal received from a single or multiple network access nodes.

In an implementation form of a client device according to the first aspect, the channel variation metric is a correlation metric indicating a correlation between the first channel estimate and the second channel estimate.

An advantage with this implementation form is that the channel variation metric captures the correlation, especially in terms of spatial and delay supports, between two different channel estimates, which may be performed on downlink reference signal received from a single or multiple network access nodes.

In an implementation form of a client device according to the first aspect,
the first channel estimate and the second channel estimate are based on measurements of reference signals transmitted from a first network access node; or
the first channel estimate is based on measurements of reference signals transmitted from a first network access node and the second channel estimate is based on measurements of reference signals transmitted from a second network access node.

An advantage with this implementation form is that the channel variation metric captures either the distance or the correlation, especially in terms of spatial and delay supports, between two different channel estimates, which may be performed on downlink reference signals received from the same or different network access nodes. Thus, the variation of the channel estimate over time or a change in the relation between at least the spatial supports of two wireless channels can be captured. A substantial variation indicates a change in large scale parameters of the channel between the client device and the network access node or between the client device and each of the network access nodes, respectively. In either case, a substantial variation indicates a movement by the client device. Measurements of reference signals from multiple network access nodes provides better diversity and increased tracking accuracy, while measurements of reference signals from a single network access node are suitable for limited capability client devices or when power savings are in order. In multi-network access node use cases, properties of the mobility pattern of the client device, e.g., direction, speed, can further be deduced from the channel variation metrics.

In an implementation form of a client device according to the first aspect,
the first channel estimate and the second channel estimate are based on measurements of reference signals transmitted at a first time instance; or
the first channel estimate is based on measurements of reference signals transmitted at a first time instance and the second channel estimate is based on measurements of reference signals transmitted at a second time instance.

An advantage with this implementation form is that distance or correlation over time, and variation between different measurements can be captured. This enables the network to use the channel variation metric to determine when a client device is moving and what the properties of its movement are. Channel variation metric prediction can also be implemented, using measurements at different time instances.

In an implementation form of a client device according to the first aspect, the first channel estimate is based on measurements of reference signals transmitted from a first network access node and the second channel estimate is based on reference measurements obtained from the first network access node or a second network access node.

An advantage with this implementation form is that no measurements are needed for the second channel estimate. The power consumption in the client device and the latency for determining the channel variation metric can thereby be reduced. Additionally, multiple reference measurements can be used, providing multiple channel variation metrics using a single measurement.

In an implementation form of a client device according to the first aspect, the first channel estimate is associated with a first position for the client device and the second channel estimate is associated with a second position for the client device different to the first position.

An advantage with this implementation form is that a substantial change in the reported channel variation metric indicates a position change by the client device. Indeed, the channel variation metrics can be used to determine, at the network side, when the client device moved and what the properties of its mobility pattern are.

In an implementation form of a client device according to the first aspect, the first control signal further indicates one or more of an antenna port, a reference signal resource and a reference signal port associated with the first channel estimate and/or the second channel estimate.

An advantage with this implementation form is that the channel variation metric may be computed based on a subset of antenna or downlink reference signal resources ports. This reduces the complexity and the time needed to compute the channel variation metric in the client device processing unit. Additionally, reduced overhead in terms of downlink reference signal can be achieved.

In an implementation form of a client device according to the first aspect, the client device is further configured to:
receive a second control signal from the network node, the second control signal indicating measurements for the channel variation metric and/or reporting of the channel variation metric;
determine the channel variation metric based on the second control signal and/or transmit the first control signal to the network node based on the second control signal.

An advantage with this implementation form is that the format of the channel variation metric, its reporting resources, its measurement resources, its measurement and/or reporting behaviors can be configured by the network node, and reconfigured when changes in the client mobility pattern calls for it.

In an implementation form of a client device according to the first aspect, the first control signal is a channel state information message or a new radio positioning protocol message.

An advantage with this implementation form is that an existing message according to the 3GPP specifications can be used, thereby minimizing changes to the 3GPP specifications and simplifying the implementation.

According to a second aspect, the above mentioned and other objectives are achieved with a network node for a communication system, the network node is configured to:
receive a first control signal from a client device, the first control signal indicating a channel variation metric between a first channel estimate and a second channel estimate for the client device.

An advantage of the network node according to the second aspect is that the client device provides the network with insightful information on the variation of the channel characteristics, especially the spatial and delay supports, with reduced reporting overhead. Using the reported channel variation metrics, the network node can determine when the client device moved and what the properties of its mobility pattern are.

In an implementation form of a network access node according to the second aspect, the channel variation metric is a distance metric indicating a distance between the first channel estimate and the second channel estimate.

An advantage with this implementation form is that the channel variation metric captures the distance, especially in terms of spatial and delay supports, between two different channel estimates, which may be performed on downlink reference signal received from a single or multiple network access node.

In an implementation form of a network access node according to the second aspect, the channel variation metric is a correlation metric indicating a correlation between the first channel estimate and the second channel estimate.

An advantage with this implementation form is that the channel variation metric captures the correlation, especially in terms of spatial and delay supports, between two different channel estimates, which may be performed on downlink reference signal received from a single or multiple network access nodes.

In an implementation form of a network access node according to the second aspect, the first control signal further indicates one or more of an antenna port, a reference signal resource and a reference signal port associated with the first channel estimate and/or the second channel estimate.

An advantage with this implementation form is that the channel variation metric may be computed based on a subset of antenna or downlink reference signal resources ports. This reduces the complexity and the time needed to compute the channel variation metric in the client device processing unit. Additionally, reduced overhead in terms of downlink reference signal can be achieved.

In an implementation form of a network access node according to the second aspect, the network node is configured to:
transmit a second control signal to the client device, the second control signal indicating measurements for the channel variation metric and/or reporting of the channel variation metric.

An advantage with this implementation form is that the format of the channel variation metric, its reporting resources, its measurement resources, its measurement and/or reporting behaviors can be configured by the network node, and reconfigured when changes in the client mobility pattern calls for it.

In an implementation form of a network access node according to the second aspect, the first control signal is a channel state information message or a new radio positioning protocol message.

An advantage with this implementation form is that an existing message according to the 3GPP specifications can be used, thereby minimizing changes to the 3GPP specifications and simplifying the implementation.

In an implementation form of a network access node according to the second aspect, the network node is configured to:
determine a measurement configuration for the client device based on the first control signal, the measurement configuration indicating one or more of a reference signal measurement, a reference signal transmission, a reference signal measurement reporting type and a reference signal measurement reporting quantity.

An advantage with this implementation form is that the network node can adapt measurements and/or measurement reporting for the client device based on movements of the client device and changes in the client device mobility pattern. Measurements and/or measurement reporting can thereby be optimized for the client device.

In an implementation form of a network access node according to the second aspect, the network node is a network access node or a location management function.

According to a third aspect, the above mentioned and other objectives are achieved with a method for a client device, the method comprises
determining a channel variation metric between a first channel estimate and a second channel estimate for the client device; and
transmitting a first control signal to a network node, the first control signal indicating the channel variation metric.

The method according to the third aspect can be extended into implementation forms corresponding to the implementation forms of the client device according to the first aspect. Hence, an implementation form of the method comprises the feature(s) of the corresponding implementation form of the client device.

The advantages of the methods according to the third aspect are the same as those for the corresponding implementation forms of the client device according to the first aspect.

According to a fourth aspect, the above mentioned and other objectives are achieved with a method for a network node, the method comprises
receive a first control signal from a client device, the first control signal indicating a channel variation metric between a first channel estimate and a second channel estimate for the client device.

The method according to the fourth aspect can be extended into implementation forms corresponding to the implementation forms of the network node according to the second aspect. Hence, an implementation form of the method comprises the feature(s) of the corresponding implementation form of the network node.

The advantages of the methods according to the fourth aspect are the same as those for the corresponding implementation forms of the network node according to the second aspect.

Embodiments of the present disclosure also relate to a computer program, characterized in program code, which when run by at least one processor causes the at least one processor to execute any method according to embodiments of the present disclosure. Further, embodiments of the present disclosure also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the present disclosure will be apparent from the following detailed description.

### BRIEF DESCRIPTION OF THE DRAWINGS

The appended drawings are intended to clarify and explain different embodiments of the invention, in which:

FIG. 1 shows a client device in accordance with one or more embodiments;

FIG. 2 shows a flow chart of a method for a client device in accordance with one or more embodiments;

FIG. 3 shows a network access node in accordance with one or more embodiments;

FIG. 4 shows a flow chart of a method for a network node in accordance with one or more embodiments;

FIG. 5 shows a communication system in accordance with one or more embodiments;

FIG. 6 shows signaling for channel variation metric reporting in accordance with one or more embodiments;

FIG. 7 shows channel variation metric reporting for positioning in accordance with one or more embodiments; and

FIG. 8 shows semi-persistent channel variation metric reporting for positioning in accordance with one or more embodiments.

### DETAILED DESCRIPTION

Positioning enhancements focused mainly on improving accuracy and latency. With the proliferation of industrial internet of things (IIoT) and devices with reduced capabilities, power efficiency became a major key performance indicator (KPI) of interest. Several solutions were proposed in order to achieve positioning KPIs with power consumption savings such as e.g., positioning sounding reference signal (SRS) configuration enhancements, positioning reference signal (PRS) transmission measurement during paging monitoring and reporting measurements performed in IDLE state.

While the proposed solutions can achieve non-negligible power savings, further enhancements can still be pursued. The ever-increasing computation capabilities and ML methods accuracy can be leveraged to this end. One approach is to reduce the number of reference signal measurements and transmissions for positioning. As positioning signals, i.e., SRS and PRS, are transmitted in a comb configuration, the client device needs to perform measurements or transmit signals over the entire bandwidth of the bandwidth part. Thus, PRS measurements and SRS transmission account for a non-negligible part of UE power consumption, during positioning procedures. Consequently, it would be beneficial to optimize PRS measurements and SRS transmissions, aiming at reducing power consumption without sacrificing accuracy.

This can be achieved by considering variation over time of positioning measurements. While mobility impacts positioning measurements, in some cases, the location of the client device may not change sufficiently to prompt new measurements and reporting for positioning. One or more embodiments of the present disclosure provide a solution to determine a channel variation metric for a client device. The channel variation metric provides information about whether the client device has moved sufficiently to prompt new positioning measurements and reporting or not. The channel variation metric may further be used to adapt CSI measurements and SRS transmission configuration or triggering, as well as to optimize beam management.

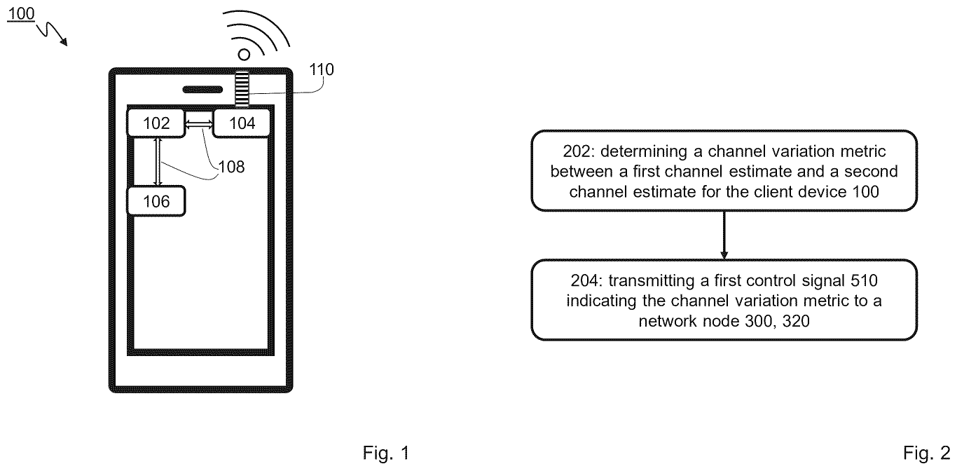

FIG. 1 shows a client device 100 according to an embodiment of the present disclosure. In the embodiment shown in FIG. 1, the client device 100 comprises a processor 102, a transceiver 104 and a memory 106. The processor 102 is coupled to the transceiver 104 and the memory 106 by communication means 108 known in the art. The client device 100 further comprises an antenna or antenna array 110 coupled to the transceiver 104, which means that the client device 100 is configured for wireless communications in a communication system.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices. The transceiver 104, memory 106 and/or processor 102 may be implemented in separate chipsets or may be implemented in a common chipset.

That the client device 100 is configured to perform certain actions can in this disclosure be understood to mean that the client device 100 comprises suitable means, such as e.g., the processor 102 and the transceiver 104, configured to perform the actions.

In some embodiments, the client device 100 is configured to determine a channel variation metric between a first channel estimate and a second channel estimate for the client device 100. The client device 100 is further configured to transmit a first control signal 510 to a network node 300, 320, the first control signal 510 indicating the channel variation metric.

In some embodiments, the client device 100 is for a communication system 500, and the client device comprises a processor configured to determine a channel variation metric between a first channel estimate and a second channel estimate for the client device 100; and a transceiver configured to transmit a first control signal 510 to a network node 300, 320, the first control signal 510 indicating the channel variation metric.

In some embodiments, the client device 100 is for a communication system 500, and the client device 100 comprises a processor and a memory having computer readable instructions stored thereon which, when executed by the processor, cause the processor to determine a channel variation metric between a first channel estimate and a second channel estimate for the client device 100; and transmit a first control signal 510 to a network node 300, 320, the first control signal 510 indicating the channel variation metric.

FIG. 2 shows a flow chart of a corresponding method 200 which may be executed in a client device 100, such as the one shown in FIG. 1. The method 200 comprises determining 202 a channel variation metric between a first channel estimate and a second channel estimate for the client device 100. The method 200 further comprises transmitting 204 a first control signal 510 to a network node 300, 320, the first control signal 510 indicating the channel variation metric.

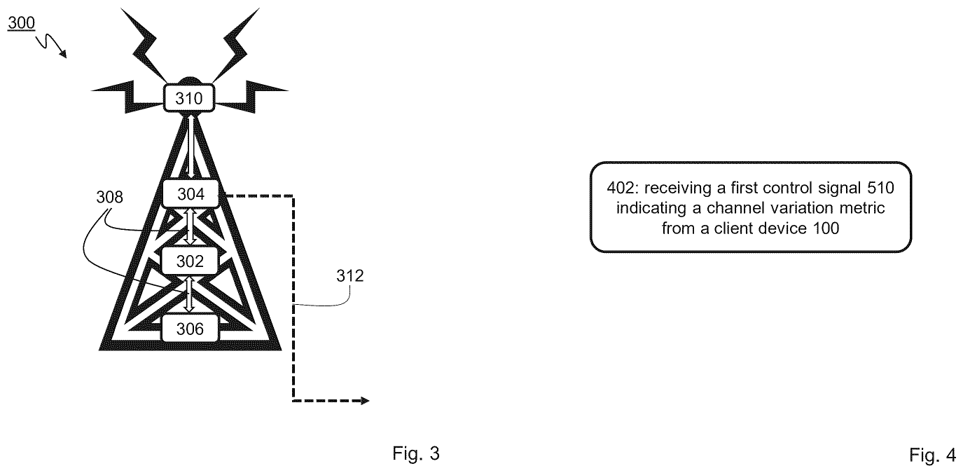

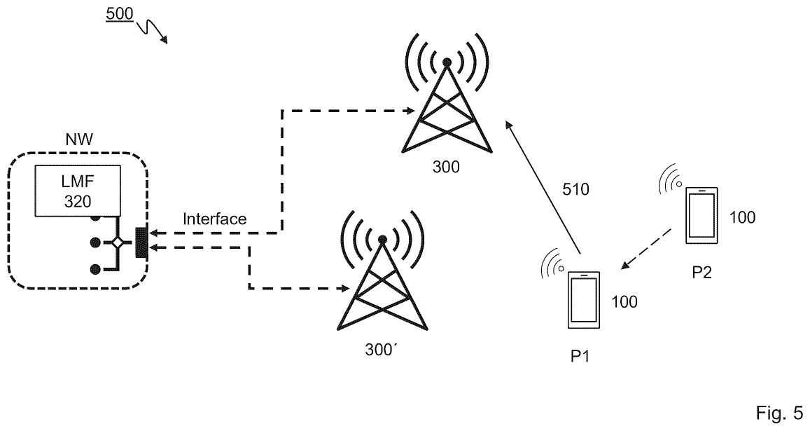

FIG. 3 shows a network node 300, 320 according to an embodiment of the present disclosure. In the embodiment shown in FIG. 3, the network node 300, 320 is a network access node 300 but the network node 300, 320 may in embodiments instead be a network function such as a location management function (LMF) 320 (see FIG. 5). With reference to FIG. 3, the network access node 300 comprises a processor 302, a transceiver 304 and a memory 306. The processor 302 is coupled to the transceiver 304 and the memory 306 by communication means 308 known in the art. The network access node 300 may be configured for wireless and/or wired communications in a communication system. The wireless communication capability may be provided with an antenna or antenna array 310 coupled to the transceiver 304, while the wired communication capability may be provided with a wired communication interface 312 e.g., coupled to the transceiver 304.

The processor 302 may be referred to as one or more general-purpose CPU, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices, such as network nodes and network servers. The transceiver 304, the memory 306 and/or the processor 302 may be implemented in separate chipsets or may be implemented in a common chipset.

That the network access node 300 is configured to perform certain actions can in this disclosure be understood to mean that the network access node 300 comprises suitable means, such as e.g., the processor 302 and the transceiver 304, configured to perform the actions.

In some embodiments, the network node 300, 320 is configured to receive a first control signal 510 from a client device 100, the first control signal 510 indicating a channel variation metric between a first channel estimate and a second channel estimate for the client device 100.

In some embodiments, the network node 300, 320 is for a communication system 500, and the network node 300, 320 comprises a transceiver configured to receive a first control signal 510 from a client device 100, the first control signal 510 indicating a channel variation metric between a first channel estimate and a second channel estimate for the client device 100.

In some embodiments, the network node 300, 320 is for a communication system 500, and the network node 300, 320 comprises a processor and a memory having computer readable instructions stored thereon which, when executed by the processor, cause the processor to receive a first control signal 510 from a client device 100, the first control signal 510 indicating a channel variation metric between a first channel estimate and a second channel estimate for the client device 100.

FIG. 4 shows a flow chart of a corresponding method 400 which may be executed in a network node 300, 320, such as the network access node 300 shown in FIG. 3 or a LMF 320. The method 400 comprises receiving 402 a first control signal 510 from a client device 100, the first control signal 510 indicating a channel variation metric between a first channel estimate and a second channel estimate for the client device 100.

FIG. 5 shows a communication system 500 according to an embodiment of the present disclosure. The communication system 500 in the disclosed embodiment comprises a client device 100, a first network access node 300 and a second network access node 300′ configured to communicate and operate in the communication system 500. The network access nodes 300, 300′ may be connected to a network NW such as e.g., a core network over a communication interface. The network NW may comprise a number of network nodes and functions such as e.g., a LMF 320. The communication system 500 may be a communication system according to the 3GPP standard such as e.g., a 5G system in which case the client device 100 may be a user equipment (UE) and the network access nodes 300, 300′ may be next generation node Bs (gNBs) or transmission reception points (TRPs) but not limited thereto.

In the shown embodiment, it is assumed that the client device 100 has been configured by the LMF 320 to perform positioning measurements, e.g., make measurements on PRSs from the first network access node 300 and/or the second network access node 300′. The PRSs measurements may be reported to the LMF 320 in the network NW via the first network access node 300 and other network functions such as an access and mobility management function (AMF). To reduce the power consumption in the client device 100, it is desirable to reduce the number of PRS measurements and/or SRS transmissions. At the same time, the positioning accuracy should not be degraded. To achieve this, it would be beneficial to know whether the position of the client device 100 has change sufficiently to prompt new PRS measurements or not.

With reference to FIG. 5, a change in position of the client device 100 from a second position P2 to a first position P1 between two consecutive PRS measurements may e.g., be large and lead to different downlink beams for the client device 100 in the second position P2 and the first position P1, respectively. In this case, the second PRS measurement provides valuable information about the position of the client device 100, i.e., that the client device 100 has moved significantly. However, if the distance between the second position P2 and the first position P1 is small enough, the client device 100 receives the same downlink beam for both the consecutive PRS measurements occasions and the second PRS measurement may not provide any new information. In this case, the second PRS measurement could be skipped without affecting the positioning accuracy.

According to various embodiments, the client device 100 is enabled to determine a channel variation metric between a first channel estimate and a second channel estimate. The channel variation metric indicates whether the position of the client device 100 or the large scale channel parameters for the client device 100 have changed or not. The first channel estimate may be associated with the first position P1 for the client device 100 and the second channel estimate may be associated with the second position P2 for the client device 100 different to the first position P1.

The client device 100 can transmit the channel variation metric to the first network access node 300 or the LMF 320 which can use the channel variation metric to track the position of the client device 100 or the large scale channel parameters for the client device 100 and e.g., determine whether positioning measurements are needed or not. With reference to FIG. 5, the client device 100 can transmit the channel variation metric to the first network access node 300 using a first control signal 510.

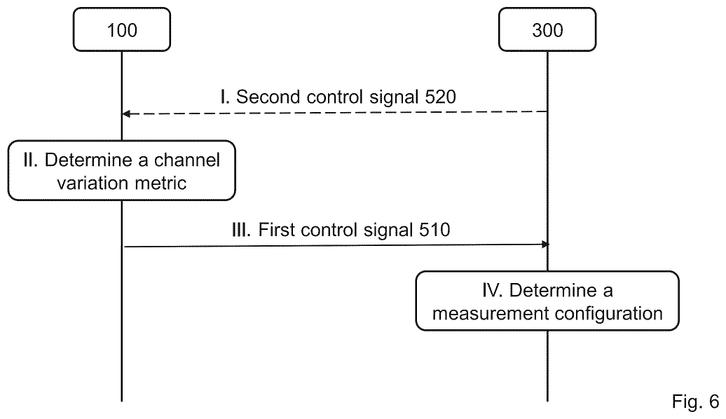

FIG. 6 shows signaling for channel variation metric reporting according to an embodiment of the present disclosure. The channel variation metric is determined by the client device 100 and provided to the network node 300, 320. The network node 300, 320 may be a network access node 300 or a network function such as a LMF 320.

In the shown embodiment, the channel variation metric reporting is initiated by the network node 300, 320 configuring the client device 100 to determine and/or transmit the channel variation metric. In step I in FIG. 6, the network node 300, 320 hence transmits a second control signal 520 to the client device 100. The second control signal 520 indicates measurements for the channel variation metric and/or reporting of the channel variation metric. The second control signal 520 may e.g., indicate a format of the channel variation metric, measurements resources for the channel variation metric, channel variation metric reporting resources, measurement and/or reporting behavior, etc. The second control signal 520 may e.g., be provided to the client device 100 during radio resource (RRC) configuration and/or reconfiguration.

Step I in FIG. 6 is optional. In embodiments, the client device 100 may determine the channel variation metric and/or reporting of the channel variation metric without receiving the second control signal 520 from the network node 300, 320. The client device 100 may e.g., be pre-configured to perform these actions or may trigger these actions based on one or more conditions, either autonomously or based on a control signal from the network node 300, 320 or another network node. In this case, the client device 100 may report channel variation metrics, when the conditions are met. Such conditions may include a threshold for the channel variation metric below or above which reporting is performed. Additionally, timer, measurement interval or number of measurement conditions may be configured. In this case, the client device 100 may initiate reporting of the channel variation metric, once conditions are verified for a configured timer duration, measurement interval or for a given number of measurements.

With reference to FIG. 6, the client device 100 receives the second control signal 520 from the network node 300, 320 and hence obtains the indicated measurements for the channel variation metric and/or reporting of the channel variation metric. Based on the second control signal 520, the client device 100 then determines the channel variation metric and/or transmit a first control signal 510 to the network node 300, 320. Thus, in the embodiment shown in FIG. 6, the client device 100 performs steps II and III based on the measurement and/or reporting configuration indicated in the second control signal 520. But the client device 100 may in other embodiments perform steps II and III in FIG. 6 without first receiving the second control signal 520 from the network node 300, 320.

In step II in FIG. 6, the client device 100 determines the channel variation metric between a first channel estimate and a second channel estimate for the client device 100. The first channel estimate and the second channel estimate may be based on measurements of reference signals transmitted from one or more network access nodes 300, 300′, i.e., based on downlink reference signal measurements. Different downlink reference signals may be used for the measurements. The client device 100 may e.g., use measurements on downlink reference signals such as channel state information—reference signal (CSI-RS) for CSI reporting and/or mobility, tracking reference signal (TRS), demodulation reference signal (DMRS) and/or synchronization signal block (SSB) to derive the first channel estimate and/or the second channel estimate and determine the channel variation metric. The first channel estimate and/or the second channel estimate may be channel estimates derived for determining the channel variation metric or may be channel estimates which the client device 100 derives for other purposes and which can be reused to determine the channel variation metric, e.g., channel estimation for CSI computations.

The first channel estimate and/or the second channel estimate may be a channel matrix, a precoding matrix indicator (PMI) or a channel covariance matrix, either wideband or computed per subband, or a channel support in the spatial and/or delay domains, but is not limited thereto.

In embodiments, the first channel estimate and the second channel estimate are based on measurements of reference signals transmitted from the first network access node 300. The first channel estimate may further be based on measurements of reference signals transmitted from the first network access node 300 and the second channel estimate may be based on measurements of reference signals transmitted from the second network access node 300′. The first channel estimate and the second channel estimate may further be based on measurements of reference signals transmitted at a first time instance; or the first channel estimate may be based on measurements of reference signals transmitted at a first time instance and the second channel estimate may be based on measurements of reference signals transmitted at a second time instance. The client device 100 may hence derive the first channel estimate and the second channel estimate from measurements of downlink reference signals from the first network access node 300 and/or the second network access node 300′ at the first time instance and/or the second time instance.

When measurements are performed on downlink reference signals received from the same network access node 300, the variation of the channel estimate, over time, is captured. A substantial variation indicates a change in the large scale parameters of the channel between the client device and the network access node 300. When measurements are performed on downlink reference signal received from at least two network access nodes 300, 300′, the channel variation metric captures the change in the relation between at least the spatial supports of the two wireless channels. A substantial variation indicates a change in the large scale parameters of the channels between the client device and each of the network access nodes, respectively. In either case, a substantial variation indicates a movement by the client device. Based on channel variation metric computation, in multi-network access node use cases, properties of the mobility pattern of the client device 100, e.g., direction, speed, can be deduced from the channel variation metrics.

Furthermore, the first channel estimate may be based on measurements of reference signals transmitted from the first network access node 300 and the second channel estimate may be based on reference measurements obtained from the first network access node 300 or the second network access node 300′. The client device 100 may e.g., obtain the reference measurements in a configuration from the network node 300, 320, e.g., in the second control signal 520.

The measurements to obtain the first channel estimate and/or the second channel estimate can further be performed on all or a subset of antenna ports, as well as on all or a subset of downlink reference signal resources ports. When a subset of antenna ports and/or downlink reference signal resources ports is used, the client device 100 may further report antenna port selection and/or downlink reference signal resources port selection together with the determined channel variation metric, as described with reference to step II in FIG. 6.

The client device 100 may determine the channel variation metric in a number of different ways. In embodiments, the channel variation metric is a distance metric indicating a distance between the first channel estimate and the second channel estimate. The distance metric may e.g., be a Log Euclidean distance or a Jensen-Bregman LogDet Divergence considering one or multiple reference signal measurement occasions. The Log Euclidean distance may be computed using the following formula:

$${d}_{LogEuc} ( {R}_{k} , {R}_{j} ) = {‖ log {R}_{k} - log {R}_{j} ‖}_{F}$$

Where Rₖ is a matrix representing the first channel estimate, Rⱼ is a matrix representing the second channel estimate.

The Jensen-Bregman LogDet Divergence may be computed using the following formula:

$${d}_{LogEuc} ( {R}_{k} , {R}_{j} ) = log det ( \frac{1}{2} ( {R}_{k} + {R}_{j} ) ) - \frac{1}{2} log det ( {R}_{k} {R}_{j} )$$

Where Rₖ is a matrix representing the first channel estimate, Rⱼ is a matrix representing the second channel estimate.

In embodiments, the channel variation metric is a correlation metric indicating a correlation between the first channel estimate and the second channel estimate, e.g., Pearson correlation coefficient or 2-D cross-correlation coefficients.

As the client device 100 is mobile, the client device 100 may change position between the first channel estimate and the second channel estimate. The first channel estimate may hence be associated with a first position P1 for the client device 100 and the second channel estimate may be associated with a second position P2 for the client device 100 different to the first position P1, as described with reference to FIG. 5. The determined channel variation metric indicates how much the second position P2 differs from the first position P1 and hence how much the client device 100 has moved.

In step III in FIG. 6, the client device 100 transmits a first control signal 510 to the network node 300, 320, the first control signal 510 indicates the determined channel variation metric. In embodiments, the first control signal 510 is a CSI message or a new radio positioning protocol (NRPP) message. When the network node 300, 320 is a network access node 300, 300′, the client device 100 may e.g., indicating the channel variation metric in a CSI report to the network access node 300, 300′. When the network node 300, 320 is a LMF 320, the client device 100 may e.g., use a RRC message and a new NRPP message to indicate the channel variation metric or an existing NRPP message according to the 3GPP specifications modified to allow indication of the channel variation metric.

The first control signal 510 may further indicate one or more of an antenna port, a reference signal resource and a reference signal port associated with the first channel estimate and/or the second channel estimate. In this way, information about the measurements used to determine the channel variation metric can be provided to the network node 300, 320. This gives the network node 300, 320 further valuable information about the client device 100 and its mobility. The antenna port, the reference signal resource and/or the reference signal port may be indicated in the first control signal 510 e.g., in the form of a bitmap. Depending on the channel conditions, e.g., number of multipath components, restricting the number of antenna ports can improve the accuracy of position variation reporting and reduce the complexity of relevant computations.

The network node 300, 320 receives the first control signal 510 from the client device 100 and hence obtains the channel variation metric indicated in the first control signal 510. As previously described, the channel variation metric is determined by the client device 100 based on a first channel estimate and a second channel estimate for the client device 100 and may indicate a distance or a correlation between the first channel estimate and the second channel estimate. The channel variation metric allows the network node 300, 320 to determine whether the position and/or large scale channel parameters for the client device 100 has changed. The network node 300, 320 may use the information derived from the channel variation metric to adapt measurements and/or measurement reporting for the client device 100, such as e.g., CSI measurements, CSI measurement reporting, positioning measurements and/or positioning measurement reporting. In embodiments, the network node 300, 320 may e.g., activate a downlink reference signal measurement for the client device 100, activate sounding reference signal transmission from the client device 100, and/or activate CSI or positioning measurement reporting for the client device 100 based on the first control signal 510. The network node 300, 320 may further use the channel variation metric to optimize beam management, e.g., perform measurements for beam indication and/or selection based on the channel variation metric. In this way, measurements for beam indication and/or selection can be performed only when a large enough change in the channel spatial support is detected.

In embodiments, the network node 300, 320 may determine a measurement configuration for the client device 100 based on the first control signal 510, as shown in step IV in FIG. 6. The measurement configuration may indicate a configuration for measurements and/or measurement reporting. In embodiments, the measurement configuration indicates one or more of a reference signal measurement, a reference signal transmission, a reference signal measurement reporting type and a reference signal measurement reporting quantity. The measurement configuration may e.g., be associated with positioning and indicate PRS measurements, SRS transmissions and/or PRS measurement reporting behavior. With the measurement configuration, the network node 300, 320 may reconfigure the measurement and/or reporting behavior of the client device 100. The network node 300, 320 may e.g., transmit the determined measurement configuration to the client device 100 in a RRC reconfiguration message (not shown in FIG. 6).

When the first control signal 510 further indicates one or more of an antenna port, a reference signal resource and a reference signal port associated with the first channel estimate and/or the second channel estimate, the network node 300, 320 may use the information to determine spatial and/or delay support of the wireless channel when downlink reference signal resources are precoded in spatial and/or delay domains.

The client device 100 may perform the measurements and/or reporting of the channel variation metric in a periodic, a semi-persistent, an aperiodic or an event-triggered way. The client device 100 may e.g., be configured by the network node 300, 320 to perform periodic, semi-persistent, aperiodic or event-triggered measurements and/or reporting of the channel variation metric using the second control signal 520. When reporting is configured as event-triggered, a set of conditions may be configured for verification before reporting of the channel variation metric.

The client device 100 may report single instance of the channel variation metric or a sequence of channel variation metrics, e.g., jointly encoded, representing a time series of measurements. A sequence of channel variation metrics may be used to predict multiple future time steps. A time series of channel variation metrics may e.g., be used as input for a prediction model which either detects movement of the client device 100 or predicts values for the channel variation metric for future time steps. Consequently, reporting requirements may further be reduced.

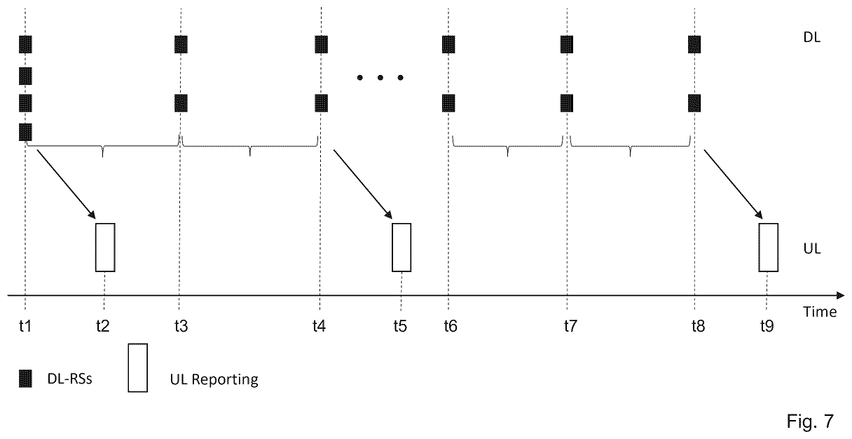

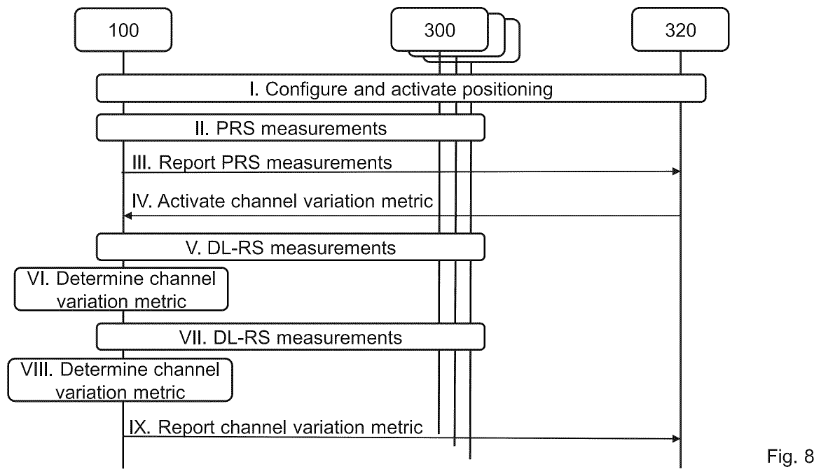

Further details related to embodiments where the channel variation metric is used in a positioning scenario will now be described with reference to FIGS. 7 and 8.

FIG. 7 shows channel variation metric reporting for positioning according to an embodiment of the present disclosure. At a first time instance t1, the client device 100 receives PRSs in downlink DL from one or more network access nodes 300. The client device 100 computes positioning measurements based on the received PRSs and reports the positioning measurements in uplink UL at a second time instance t2.

The client device 100 periodically received DL-RSs, as shown in FIG. 7, and determines a channel variation metric based on channel estimates derived from measurements on the received downlink reference signals DL-RSs. The downlink reference signals DL-RSs may e.g., be CSI-RS, TRS, DMRS, SSB and/or PRS. The determined channel variation metrics are evaluated to determine if conditions for reporting the channel variation metrics are met or not. In the shown embodiment, the reporting conditions are met at a fourth time instance t4 and an eight time instance t8. This triggers the reporting of the channel variation metrics. With reference to FIG. 7, the client device 100 hence transmits a uplink UL report indicating the determined channel variation metric at a fifth time instance t5 and at a ninth time instance t9, respectively. The uplink UL report may comprise the channel variation metric as a standalone quantity or may further comprise positioning measurements. If the channel variation metric is reported as a standalone quantity, the network may trigger reporting of positioning measurements in response to the received channel variation metric. In other words, the network may adapt positioning measurements for the client device 100 based on the received channel variation metrics.

FIG. 8 shows semi-persistent channel variation metric reporting for positioning according to an embodiment of the present disclosure. In the shown embodiment, the channel variation metric reporting is activated and/or de-activated for the client device 100 by the LMF 320.

In step I in FIG. 8, configuration and activation of positioning for the client device 100 are performed between the client device 100 and the LMF 320. Conventional procedures for configuration and activation of positioning according to the 3GPP specifications may e.g., be used.

Based on the configuration and activation of positioning, the client device 100 performs PRS measurements on PRSs from one or more network access nodes 300 and reports the PRS measurements to the LMF 320, as shown in steps II and III in FIG. 8.

In step IV in FIG. 8, the LMF 320 activates channel variation metric reporting for the client device 100. The activation, as well as a de-activation, of channel variation metric reporting may be conveyed from the LMF 320 to the client device 100 as part of positioning protocol messages. Alternatively, a RRC message or dynamic layer one L1 and/or layer two L2 signaling may be used, e.g., uplink control information (UCI) or a medium access control-control element (MAC-CE).

Based on the activation of channel variation metric reporting, the client device 100 starts to measure DL-RSs from one or more network nodes 300 and to determine channel variation metrics based on the measurements, as shown in step V to VIII in FIG. 8. The DL-RSs may be DL-RSs such as CSI-RS for CSI reporting/mobility, TRS, DMRS, SSB and/or PRS.

The client device 100 further evaluates the determined channel variation metrics based on a reporting condition to determine whether the channel variation metric are to be reported to the LMF 320. In FIG. 8, the client device 100 determines that the reporting conditions are met for the channel variation metric determined in step VIII in FIG. 8. Consequently, the client device 100 reports the channel variation metric to the LMF 320, as shown in step IX in FIG. 8. The client device 100 may further report time series of the channel variation metric, e.g., report both the channel variation metric determined in step VI in FIG. 8 and the channel variation metric determined in step VIII in FIG. 8.

The client device 100 may continue to determine and reporting channel variation metrics until channel variation metric reporting is de-activated by the LMF 320 (not shown in FIG. 8), i.e., until the client device 100 receives a de-activation command from the LMF 320 e.g., in a positioning protocol messages, a RRC message, UCI or MAC-CE.

The client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant media access control (MAC) and physical layer (PHY) interface to the wireless medium (WM). The UE may be configured for communication in 3GPP related long term evolution (LTE), LTE-advanced, fifth generation (5G) wireless systems, such as new radio (NR), and their evolutions, as well as in IEEE related Wi-Fi, worldwide interoperability for microwave access (WiMAX) and their evolutions.

The network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access nodes may be of different classes or types such as e.g., macro eNodeB, home eNodeB or pico base station, based on transmission power and thereby the cell size. The radio network access node may further be a station, which is any device that contains an IEEE 802.11-conformant MAC and PHY interface to the WM. The radio network access node may be configured for communication in 3GPP related LTE, LTE-advanced, 5G wireless systems, such as NR and their evolutions, as well as in IEEE related Wi-Fi, WiMAX and their evolutions.

Furthermore, any method according to the embodiments of the present disclosure may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the client device and the network access node comprise communication capabilities in the form of e.g., functions, means, units, elements, etc., for performing or implementing embodiments of the present disclosure. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the client device and the network access node may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the present disclosure is not limited to the embodiments described above, but also relates to and incorporates all embodiments within the scope of the appended independent claims.

1. A client device for a communication system, the client device being configured to:
determine a channel variation metric between a first channel estimate and a second channel estimate for the client device; and
transmit a first control signal to a network node, the first control signal indicating the channel variation metric.

2. The client device according to claim 1, wherein the channel variation metric is a distance metric indicating a distance between the first channel estimate and the second channel estimate.

3. The client device according to claim 1, wherein the channel variation metric is a correlation metric indicating a correlation between the first channel estimate and the second channel estimate.

4. The client device according to claim 1, wherein
the first channel estimate and the second channel estimate are based on measurements of reference signals transmitted from a first network access node; or
the first channel estimate is based on measurements of reference signals transmitted from the first network access node and the second channel estimate is based on measurements of reference signals transmitted from a second network access node.

5. The client device according to claim 1, wherein
the first channel estimate and the second channel estimate are based on measurements of reference signals transmitted at a first time instance; or
the first channel estimate is based on measurements of reference signals transmitted at the first time instance and the second channel estimate is based on measurements of reference signals transmitted at a second time instance.

6. The client device according to claim 1, wherein the first channel estimate is based on measurements of reference signals transmitted from a first network access node and the second channel estimate is based on reference measurements obtained from the first network access node or a second network access node.

7. The client device according to claim 1, wherein the first channel estimate is associated with a first position for the client device and the second channel estimate is associated with a second position for the client device different to the first position.

8. The client device according to claim 1, wherein the first control signal further indicates one or more of an antenna port, a reference signal resource or a reference signal port associated with at least one of the first channel estimate or the second channel estimate.

9. The client device according to claim 1, wherein the client device is further configured to:
receive a second control signal from the network node, the second control signal indicating measurements for at least one of the channel variation metric or reporting of the channel variation metric;
determine the channel variation metric based on at least one of the second control signal or transmit the first control signal to the network node based on the second control signal.

10. The client device according to claim 1, wherein the first control signal is a channel state information message or a new radio positioning protocol message.

11. A network node for a communication system, the network node being configured to:
receive a first control signal from a client device, the first control signal indicating a channel variation metric between a first channel estimate and a second channel estimate for the client device.

12. The network node according to claim 11, wherein the channel variation metric is a distance metric indicating a distance between the first channel estimate and the second channel estimate.

13. A method for a client device, the method comprising:
determining a channel variation metric between a first channel estimate and a second channel estimate for the client; and
transmitting a first control signal to a network node, the first control signal indicating the channel variation metric.

14. The method according to claim 13, wherein the channel variation metric is a distance metric indicating a distance between the first channel estimate and the second channel estimate.

15. The method according to claim 13, wherein the channel variation metric is a correlation metric indicating a correlation between the first channel estimate and the second channel estimate.

16. The method according to claim 13, wherein
the first channel estimate and the second channel estimate are based on measurements of reference signals transmitted from a first network access node; or
the first channel estimate is based on measurements of reference signals transmitted from the first network access node and the second channel estimate is based on measurements of reference signals transmitted from a second network access node.

17. The method according to claim 13, wherein
the first channel estimate and the second channel estimate are based on measurements of reference signals transmitted at a first time instance; or
the first channel estimate is based on measurements of reference signals transmitted at the first time instance and the second channel estimate is based on measurements of reference signals transmitted at a second time instance.

18. The method according to claim 13, wherein the first channel estimate is based on measurements of reference signals transmitted from a first network access node and the second channel estimate is based on reference measurements obtained from the first network access node or a second network access node.

19. The method according to claim 13, wherein the first channel estimate is associated with a first position for the client device and the second channel estimate is associated with a second position for the client device different to the first position.

20. A method for a network node, the method comprising
receiving a first control signal from a client device, the first control signal indicating a channel variation metric between a first channel estimate and a second channel estimate for the client device.
